(19) United States
(12) Patent Application Publication
(10) Pub. No.: US 2011/0031334 A1
(43) Pub. Date: Feb. 10, 2011

(54) HIGH PRESSURE HOSE APPARATUS AND METHOD OF USE

(76) Inventors: Michael T. Merritt, Kingston, NH (US); David J. Delage, Madison, TN (US)

Correspondence Address: KEVIN FARRELL;PIERCE ATWOOD, ONE NEW HAMPSHIRE AVENUE, PORTSMOUTH, NH, 03801, US

(21) Appl. No.: 12/696,131

(22) Filed: Jan. 29, 2010

Related U.S. Application Data
(60) Provisional application No. 61/152,523, filed on Feb. 13, 2009.

(51) Int. Cl. B05B 1/14

(52) U.S. Cl. 239/590

(57) ABSTRACT

The present invention is directed to lighting and safety switch systems for use with high pressure hoses. One embodiment comprises a multipoint light source disposed around the high pressure hose and located proximate the discharge port for uniformly illuminating the application surface without casting a shadow. Another embodiment comprises at least one low profile, elongated switching element for activating and deactivating dispensing of pressurized medium through the high pressure hose. The at least one switching element is substantially equally responsive to touch along its length and runs parallel to the high pressure hose.

### BACKGROUND

1. Field of the Invention

The present invention relates generally to high pressure blasting devices and more particularly to ergonomic safety aids for use with high pressure hoses dispensing pressurized media.

2. Discussion of Background Information

High pressure hoses exist for a number of uses. For example, firemen use high pressure water hoses routinely to extinguish conflagrations, and surface treatment services use high pressure hoses for transferring pressurized fluid and/or abrasive blast medium to surfaces covered with debris, coatings or contaminants such as oil, paint, biological buildup and grease. These pressurized hoses are typically hundreds of feet in length and exhibit high torque forces in use. Operators handling such hoses must physically overpower such forces while directing the fluid and/or abrasive medium to particular target areas requiring treatment. Losing control of such a house could result in the pressurized hose whipping about, wildly dispensing pressurized medium and potentially injuring operators and damaging property.

Manual abrasive blasting, for example, generally involves an operator holding an abrasive blast hose that propels a high pressure medium of air and abrasive through hundreds of feet of hose and onto an application surface no less than approximately 18 to 24 inches from the dispensing port of the hose. The high pressure medium exits the high pressure hose at near supersonic speeds, and an operator must direct the flow of the rapidly moving medium onto a target area. These abrasive blast hoses often support a retro-fitted light to illuminate the application surface and assist operators with viewing the target area. Such a light source typically clamps to the high pressure hose and stands approximately 6 inches above the line of the hose. Such positioning of these single source lights projects a shadow of the hose and/or hose nozzle onto the application surface. The positioning of such a light above a hose also creates an impediment to moving the high pressure hose into tight spaces. Additionally, these lights heat up quickly without adequate convective or conductive cooling and break frequently because pressurized medium moves at near supersonic speeds upon deployment, rebounds from application surfaces, and impinges on such lights. Another concern arises in connection with the pressurized medium exiting the high pressure hose at near supersonic speeds. An abrasive blast medium moving at such speeds creates static electricity arcing between the exit of the high pressure hose and the application surface. An overheating light or sparks from a breaking light could cause an explosion.

In addition to a light source, a high pressure hose, such as an abrasive blast hose, often comprises a safety control switch, a “deadman,” near the operator handhold for activating dispensing the pressurized blast medium. Such safety control deadman switches are generally either pneumatically or electrically activated and are designed to require compression at all times to signal a continuous flow of pressurized medium. If an operator looses control or falls unconscious, dropping the high pressure hose and releasing the deadman switch, the flow of pressurized medium will cease, thereby protecting the operator and the application surface.

Some deadman switches use a ball or cone system to wedge open a power toggle switch and a lanyard that attaches to the ball or cone on one end and to the wrist of an operator on the other end. These safety lanyards operate on the principle that if an operator loses control and drops the high pressure hose, the lanyard will pull the ball or cone out from under the operation switch, thereby releasing the power toggle switch and powering down the system.

Blasting environments are harsh, however, and these largely mechanical deadman switches sometimes malfunction because airborne pressurized medium accrues on, beneath and between moving components responsible for activation and deactivation of the dispensing mechanism. Furthermore, these commonly applied deadman switches adhere to a single location on the pressurized hose and are neither ergonomic nor user friendly. Operators often need to move their hands up and down along the blast hose or nozzle depending on their stance and position. The single, fixed location of a deadman switch limits such repositioning. More problematic is that many operators override these safety switches by wrapping straps around the handles of their deadman switches to free their hands for comfortable positioning elsewhere along the high pressure hose.

A need therefore exists for a reliable, safe and accurate lighting system and a reliable, safe, and ergonomic safety switch system for use with high pressure hoses.

### SUMMARY OF THE INVENTION

The present invention solves the problems associated with existing high pressure hose switches and lights and provides reliable, safe, ergonomic lighting and safety switch systems.

One embodiment of the present invention is directed to a lighting system integrated with a high pressure hose for uniformly illuminating an application surface treated by a pressurized medium exiting a hose discharge nozzle at a discharge port. The lighting system comprises a housing disposed on the hose discharge nozzle such that the housing fully encircles the discharge nozzle without blocking the discharge port. The housing is adapted for engaging a light fixture disposed on the hose discharge nozzle and engaged with the housing proximate the discharge port. The light system further comprises two or more lights disposed on the lighting fixture, the two or more lights being spaced apart about the hose discharge nozzle to uniformly illuminate the application surface without casting a shadow of the hose discharge nozzle.

Another embodiment of the present invention is directed to an ergonomic actuation system for selectively discharging a pressurized medium from a discharge nozzle of a high pressure hose. The ergonomic actuation system comprises at least one switching element and a communication means linking the at least one switching element to a control system of the discharge unit to communicate starting or stopping flow of the dispensed pressurized medium in response respectively to grasping or releasing the at least one switch. The at least one switching element is responsive to touch and disposed on the outer surface of the hose proximate to the discharge nozzle. Activation of the at least one switching element signals a discharge unit to discharge pressurized medium through the high pressure hose. The at least one switching element is substantially equally responsive at all points along its length. Furthermore, the at least one switching element adds no more than 1 inch to the outer diameter of the high pressure hose, is at least 1 foot in length, and runs parallel to the high pressure hose.

### BRIEF DESCRIPTION OF THE DRAWINGS

One will better understand these and other features, aspects, and advantages of the present invention following a review of the description, appended claims, and accompanying drawings in which:

FIG. 1A shows a perspective end view of one embodiment of the present invention.

FIG. 1B shows a side cross sectional view of one embodiment of the present invention.

FIG. 1C shows an alternate perspective end view of one embodiment of the present invention.

FIG. 2A shows a side cross sectional view of one embodiment of the lighting system of the present invention.

FIG. 2B shows an end view of one embodiment of the lighting system of the present invention.

FIG. 3 shows a schematic cross-section side view of one embodiment of the present invention.

FIG. 4 shows a schematic perspective view of one embodiment of the present invention.

### DETAILED DESCRIPTION

The present invention solves the problems associated with existing high pressure hose safety and lighting systems and provides reliable, safe, ergonomic safety switches and lighting systems and methods of use.

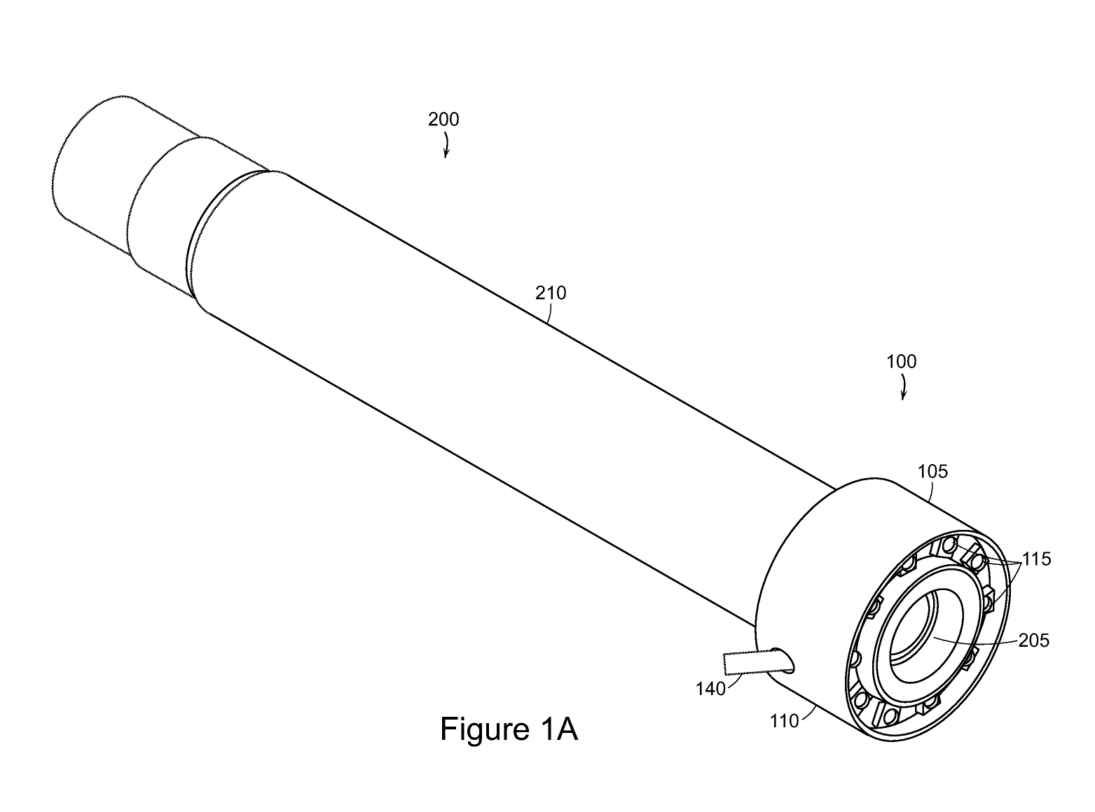

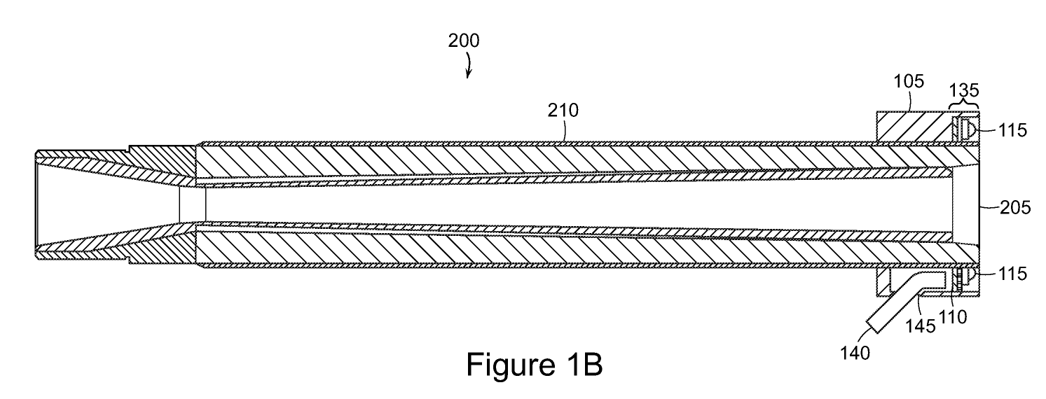

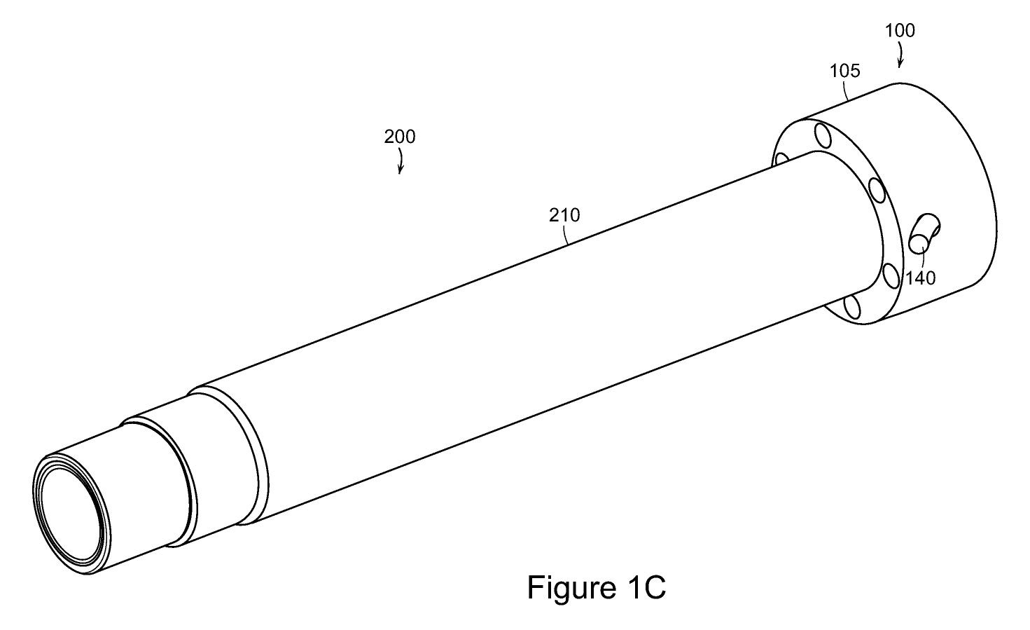

As FIGS. 1A through 1C depict, one embodiment of the present invention comprises a lighting system 100 integrated with and disposed on a high pressure hose 200 for uniformly illuminating an application surface treated by a pressurized medium flowing through the high pressure hose 200 and exiting at a discharge port 205. The pressurized medium may be any fluid or fluid-abrasive mixture. For example, the pressurized medium may be water, air, air and sand, air and sponge blast material, or air and rubber or foam. In the embodiment of FIGS. 1A through 1C, the lighting system 100 encircles the high pressure hose 200 proximate the hose discharge port 205 and is coaxial with the high pressure hose for further enabling uniform illumination. Here, the high pressure hose 200 further terminates at a discharge nozzle 210, but one skilled in the art of high pressure hoses will recognize that the lighting system 100 could integrate with the whip (not shown) of a high pressure hose 200 having no integrated discharge nozzle 210.

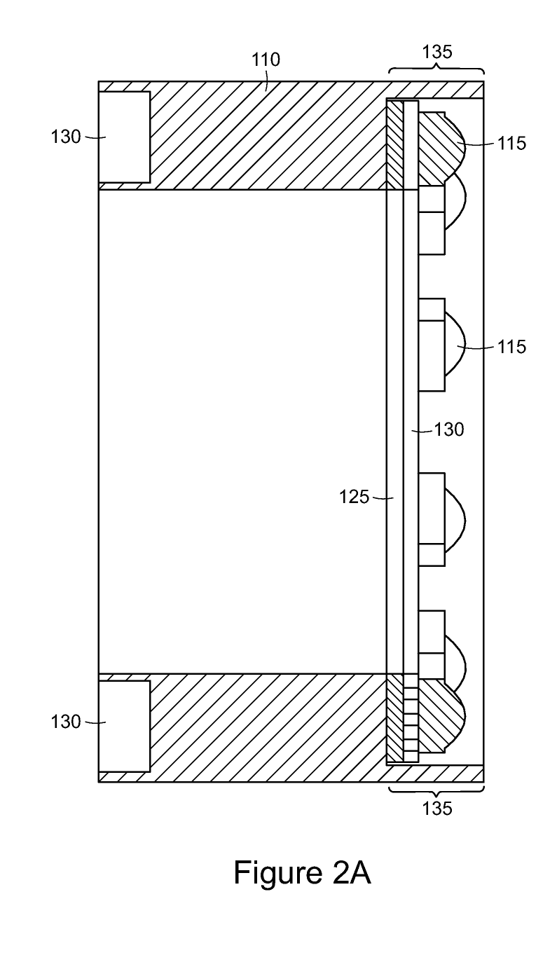

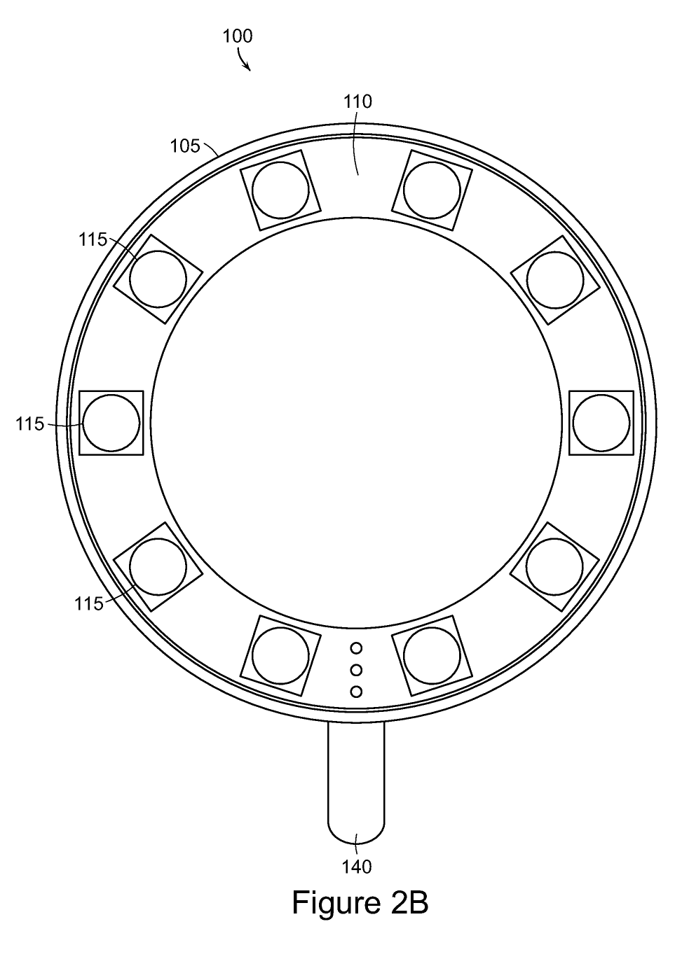

In the embodiment of FIGS. 1A through 2B, the lighting system 100 comprises a housing 105, a light fixture 110 and two or more lights 115. The housing 105 is disposed on the hose discharge nozzle 210 such that the housing 105 fully encircles the discharge nozzle 210 without blocking the discharge port 205. The housing 105 is adapted for engaging a light fixture 110, which is disposed on the hose discharge nozzle 210 proximate the discharge port 205. Two or more lights 115 are disposed on the lighting fixture 110 and spaced apart about the discharge nozzle 210 so as to uniformly illuminate an application surface treated with the pressurized medium exiting the discharge port 205. As indicated in the embodiment depicted in FIGS. 1A through 1C, the two or more lights 115 are positioned proximate the outer surface of the discharge nozzle 210 and proximate the discharge port 205 such that they uniformly illuminate the application surface without casting a shadow of the discharge nozzle 210 and/or hose 200.

In the embodiment shown, the housing 105 protects and positions the two or more lights 115 and the lighting fixture 110 proximate the discharge port 205 of the nozzle 210. In one embodiment, the housing 105 is manufactured of a sturdy material such as aluminum, which is both anti-sparking and lightweight so as to create no additional physical burden on the operator directing the high pressure hose 200. Alternatively, the housing maybe made of any lightweight, durable and/or heat dissipating material such as, for example, titanium, high density polyethylene, polyurethane, ultra high molecular weight polyethylene, flexible epoxy, polyvinylchloride or Kevlar®. One skilled in the art will recognize that certain materials provide favorable heat dissipation while others provide greater resistance to wear from rebounding pressurized medium. Selecting a material for the housing depends on a number of factors including but not limited to distance from the application surface and likelihood of rebound, the abrasiveness of the material comprising the pressurized medium, and the amount of energy generated by the two or more lights 115 and requiring heat dissipation. In some embodiments, the housing 105 may be of sufficient thickness to dissipate heat generated by the two or more lights 115, and other embodiments of the lighting system 100 may comprise a heat sink 125, such as a metal washer, disposed adjacent the two or more lights 115 and/or the light fixture 110 for assisting with heat dissipation.

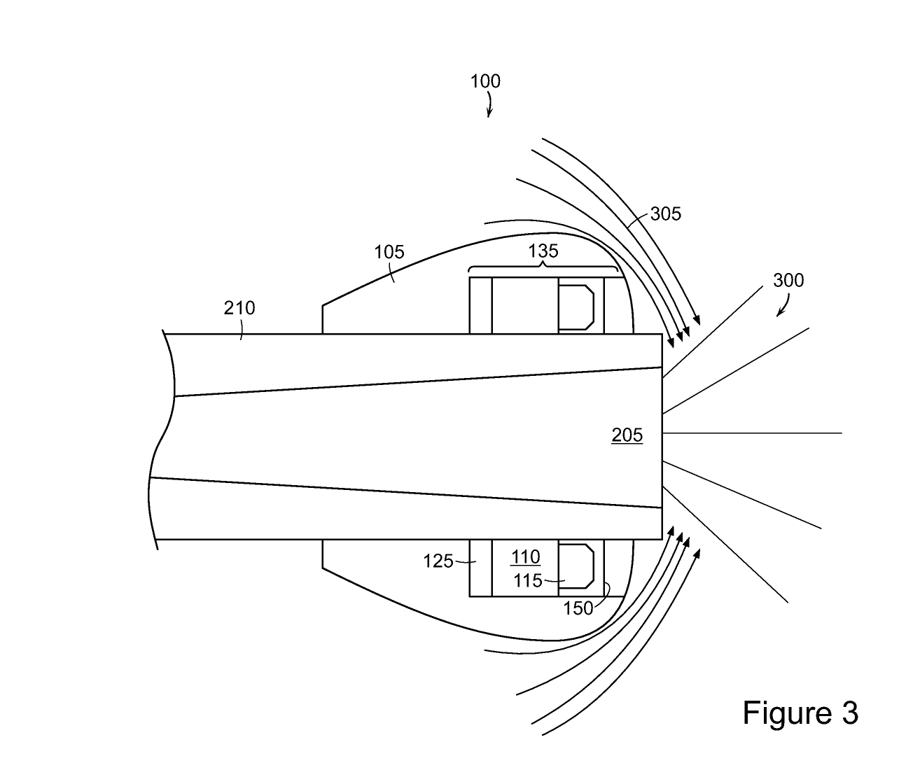

Additionally, in one embodiment, the housing 105 comprises a low profile design that adds less than 2 inches to the diameter of the hose 200. This sleek design enables an operator to access enclosed, tight or small spaces easily with the nozzle 210. The embodiment of FIGS. 1A through 2B depict a housing 105 in the shape of a right angle cylinder. Other embodiments, like that depicted in FIG. 3, may have rounded edges or a tapered cross section like that of a cambered airfoil. Such designs may assists with cooling the housing 105, the fixture 110 and the two or more lights 115. As FIG. 3 depicts, a jet 300 of pressurize medium exits the pressurized hose 200 at speeds great enough to draw airflow 305 in behind the jet 300 and over the housing 105 and dispensing port 205 of the nozzle 210. This airflow 305 assists with heat dissipation, preventing the two or more lights 115 from reaching dangerous temperatures which could potentially cause combustion of the statically charged pressurized medium in the jet 300 exiting the high pressure hose 200. In the embodiment of FIG. 3, the housing 105 is shown as having a curvilinear profile in the region of the airflow 305 so as to propagate continuous laminar air flow 305 and prevent turbulent eddies from forming and potentially disrupting effective heat dissipation. The air flow 305 further assists with preventing any particulate matter straying from the jet 300 or rebounding from the application surface from impinging upon the lighting system 100 beneath the air flow 305. This airflow thereby functions as a protective barrier covering the housing 105, light fixture 110 and two or more lights 115.

Returning to the construct of the housing 105, FIGS. 1A through 2B depict a unitary embodiment. Such an embodiment may attach to the high pressure hose 200 in a number of ways. For example, the housing 110 may attach securely to the pressure hose 200 or nozzle 210 by press fit, one or more clamps, magnets, rivets, screws, other mechanical fasteners, adhesive, or permanent welds. FIGS. 2A and 2B, for example, depict a unitary embodiment of the housing 110 having mechanical fasteners 130 engaging the housing 105 with the high pressure hose 200. In other embodiments, the housing 105 could comprise two or more pieces permanently or semi-permanently disposed on the nozzle 210 and secured to each other and or the nozzle 210 via press fit, one or more clamps, magnets, rivets, screws, other mechanical fasteners, adhesive, or permanent welds for example. In that alternate embodiment, the two or more pieces of a non-unitary housing 105 would require positioning such that the two or more lights 115 still would illuminate the application surface uniformly.

The unitary embodiment of the housing 105 of FIGS. 1A through 2B further comprises a recess 135 for receiving the light fixture 110 and two or more lights 115. Alternate embodiments may comprise no recess, and the light fixture 110 and two or more lights 115 instead may engage directly with the housing 105. For example, the light fixture 110 and/or two or more lights 115 may attach directly to an outer surface of the housing 105 via adhesive or mechanical fasteners. In yet another embodiment, the two or more lights 115 may integrate with a formed housing 105. For example, the housing 105 may be injection molded or cast around the two or more lights 115. For example, a urethane compound may be cast around two or more LED lights 115 to form a flexible wrap housing 105 for encircling the high pressure hose 200.

In any embodiment, the housing 105 is disposed on the high pressure hose 200 and/or discharge nozzle 210 proximate the discharge port 205. Placing the housing 105 proximate the discharge port 205 enables a more compact lighting system 100. Distancing the lighting system 100 from the discharge port 205 requires enlargement of the circumference of the lighting system 100 and more distal placement of the two or more lights 115 from the surface of the nozzle 210. This enlargement is necessary to prevent formation of a shadow caused by portion of the discharge nozzle 210 positioned between the two or more lights 115 and the application surface. In one embodiment, the lighting system 100 is disposed on the hose discharge nozzle 210 at a distance measuring in a range of zero to twelve inches from the discharge port 205, and the two or more lights 115 are disposed on the light fixture 110 at a radial distance of a quarter of an inch to two inches from the surface of the discharge nozzle.

In one embodiment, the light fixture 110 comprises a circuit board in wired and/or wireless communication with a regulated power source for powering the two or more lights 115 disposed on the lighting fixture 110. In the embodiment of FIGS. 1A through 1C, the light fixture 110 is in wired communication with a power source (not shown) via a power cable 140 attached to the light fixture 110 and protruding through the housing 105 at an opening 145. Alternatively, the lighting fixture 110 may operate on an independent power source such as a battery. In the embodiments of FIGS. 1A through 2B, the lighting system 100 further comprises two or more lights 115 disposed on a circuit board style light fixture 110. Here the two or more lights 115 are positioned around the discharge nozzle 210 in a circular pattern so that the application surface remains constantly uniformly illuminated irrespective of whether the high pressure hose 200 is rotated by an operator.

In addition to the circular pattern of FIGS. 1A through 2B, the two or more lights 115 may be sized, positioned and spaced in any number of configurations to achieve uniform illumination. Additionally, the two or more lights 115 could be any type of light capable of being sized and shaped for positioning around a high pressure hose 200 in a compact manner, without adding substantial girth or weight to the discharge nozzle 210. For example, the two or more lights 115 may be LED, fiber optic, halogen, fluorescent, or incandescent. Preferably, the two or more lights 115 are current controlled to compensate for potential losses over a lengthy cable 140 Powering the two or more lights 115 with a current limiting power supply maintains a constant light level whether the power cable 140 is 50 feet long or 450 feet long.

In alternate embodiments, the lighting system 100 may further comprise a protective lens 150 disposed over the two or more lights 115. The protective lens 150 may be any lightweight, light transmitting material, such as polycarbonate or glass. Additionally, embodiments may comprise a temperature sensor (not shown), such as a thermistor. The temperature sensor may be disposed on the light fixture 110 or housing 105 for communicating with a regulated power supply (not shown) to power on or off the two or more lights 115 depending on whether a critical temperature limit is reached. For example, the temperature sensor could power off the two or more lights 115 if they were to reach a temperature between a range of 60 to 110 degrees Celsius and more particularly if they were to heat to 80 degrees Celsius. Alternatively, the temperature sensor may communicate through wired or wireless means with a control system 400 for dispensing the pressurized medium, thereby stopping the flow of the pressurized medium if the two or more lights 115 were to reach a dangerous temperature that might induce combustion.

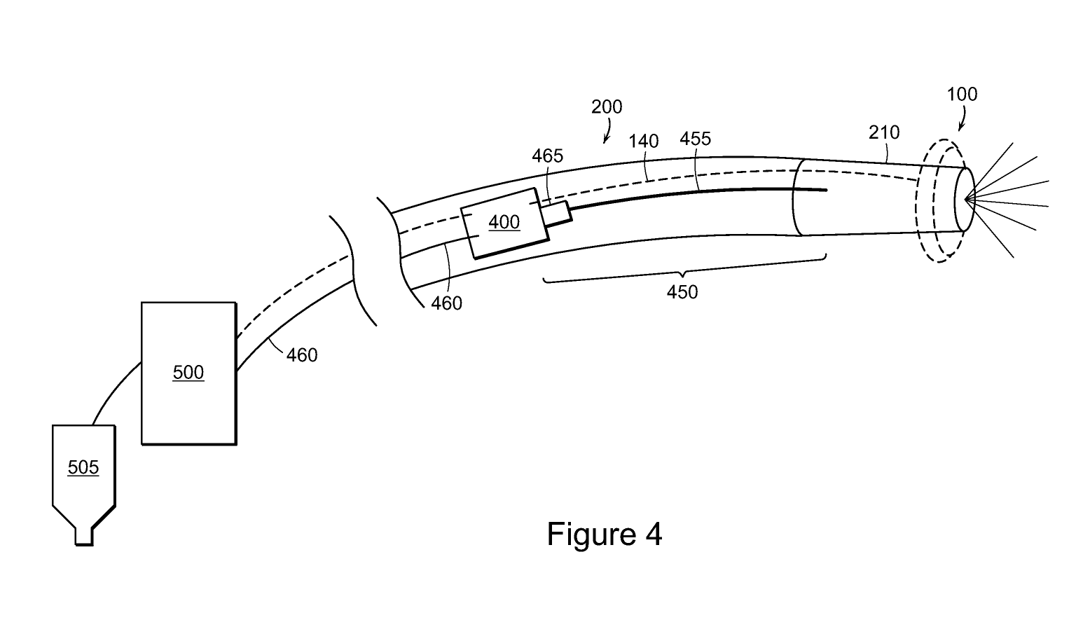

In an alternate embodiment of the present invention depicted in FIG. 4, the lighting system 100 may communicate through wired or wireless means with a control box 400. In this embodiment, the control box 400 is disposed on the high pressure hose 200 and communicates through wired or wireless means with both an ergonomic actuation system 450 and a control system 500 capable of starting and stopping the flow of dispensed pressurized medium from a discharge unit 505.

The ergonomic actuation system 450 comprises at least one switching element 455 responsive to touch and disposed on the outer surface of the high pressure hose 200 proximate the discharge nozzle 210. Activation of the at least one switching element 455 signals the control system 500 of a discharge unit 505 to discharge pressurized medium through the high pressure hose 200. The at least one switching element 455 is substantially equally responsive at all points along its length and has a low profile, thereby adding no more than one inch to the outer diameter of the high pressure hose 200.

In one embodiment, the at least one switching element 455 has a cross sectional height measuring between 5 millimeters and 13 millimeters, and more specifically measuring 6 millimeters. This low profile enables an operator to wrap a gloved hand comfortably around the high pressure house 200 and the at least one switching element 455. In one embodiment, the at least one switching element 455 is at least about one foot in length, runs parallel to the central axis of the high pressure hose 200 and extends across both the discharge nozzle 210 and a portion of the high pressure hose 200 directly adjacent the discharge nozzle 210. In yet another embodiment, the at least one switching element may be disposed entirely on the high pressure hose 200 in a location adjacent the nozzle 210 so that an operator may grasp the high pressure hose 200 comfortably anywhere along a continuous length spanned by the at least one switching element 455 and still maintain control of the pressurized medium flowing from the high pressure hose 200.

In addition to the at least one switching element 455, the ergonomic actuation system 450 comprises a communication means 460 for communicating a signal from the control box 300 to the control system 500 of the discharge unit 505 to communicate starting or stopping flow of the dispensed pressurized medium. The signal to start or stop flow is generated in response respectively to an operator grasping or releasing the at least one switch 455. In one embodiment, the communication means 460 is communication cable, such as an electrical wire. In another embodiment the communication means 460 may be a wireless signal transmitted from the communication box 400 to a receiver on the control system 500. The control box 400 also may communicate through wired or wireless means with the ergonomic actuation system 450. After receiving and interpreting a signal from the ergonomic actuation system 450, the control box 400 communicates with the control system 500 to activate or deactivate flow of pressurized medium through the high pressure hose 200. In one embodiment, the signal from the ergonomic actuation system 450 is a change in voltage, for example a change between 0V and 5V, and the control box 400 further comprises a programmable logic controller (not shown) for interpreting the signal.

In one embodiment, the at least one switching element 455 is a pneumatic system comprising a fluid filled, enclosed hose and a pressure switch 465 disposed at the end of the fluid filled enclosed hose. The pressure switch 465 senses a pressure differential induced by constriction applied by one or both hands of an operator. The pressure switch 465 communicates a signal to the control box 400 in response to the pressure differential, and the control box 400 interprets the signal and instructs the control system 500 to act accordingly. Alternatively, in other embodiments, the at least one switching element may comprise any type of low profile actuation device spanning a length of the high pressure hose 200 to enable convenient and comfortable use by an operator. For example, the at least one switching element 455 may be one or more mechanical actuators, electrical capacitance switches or hydraulic switches capable of communicating a signal to the control box 400 and/or the control system 500.

In one embodiment, the control box 400 further comprises a safety control mechanism, such as a toggle switch (not shown), that requires intentional interaction prior to touching the at least one switching element 455 to activate flow of pressurized medium. This configuration anticipates any unintentional grasping of the at least one switching element 455 and prevents transmission of an unintended signal that otherwise would power on the dispensing unit 505. In this embodiment an operator first must activate the safety switch and then must touch the at least one switching element 455 to initiate flow of the pressurized medium. Once flow begins, the operator may release the safety switch while maintaining contact with the at least one switching element 455 to maintain continuous flow of the pressurized medium. Upon releasing the at least one switching element 455 intentionally or unintentionally, the control box 400 will receive and interpret a signal to instruct the control system 500 to deactivate flow of the pressurized medium. This configuration of the at least one switching element 455 enables an operator to change stance and hand position without disrupting flow of the pressurized medium, but this configuration also anticipates a safety mechanism whereby the dispensing unit 505 will stop dispensing a flow of pressurized medium if an operator loses control of the high pressure hose 200.

Although the control box 400 is described here with regard to embodiments comprising a lighting system and/or an ergonomic actuation system 450, the control box 400 may further support addition embodiments comprising additional safety elements. For example, the control box 400 may interact through wired or wireless means with one or more audible, visual, or radio transmitted alarms for signaling a second operator when the primary operator manning a high pressure hose 200 has remained motionless for a predetermined period of time. Another embodiment may comprise a video system in wired or wireless communication with the control box 400. Such a video system may comprise a camera positioned on the high pressure hose 200 or on the body of the operator so that an electronic record may be recorded detailing work progress and quality. Such video tracking could populate a chronological database related to the item being treated with the pressurized medium, thereby creating a recorded history of work done during the life of an asset.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

We claim:

1) A lighting system integrated with a high pressure hose for uniformly illuminating an application surface treated by a pressurized medium exiting a hose discharge nozzle at a discharge port, the lighting system comprising:
a) a housing disposed on the hose discharge nozzle such that the housing fully encircles the discharge nozzle without blocking the discharge port, the housing adapted for engaging a light fixture;
b) a light fixture disposed on the hose discharge nozzle and engaged with the housing proximate the discharge port; and
c) two or more lights disposed on the light fixture, the two or more lights being spaced apart about the hose discharge nozzle to uniformly illuminate the application surface without casting a shadow of the hose discharge nozzle.

2) The lighting system of claim 1 wherein the housing is resistant to wear by the pressurized medium.

3) The lighting system of claim 1 wherein the housing is made of a substance selected from a group consisting of aluminum, titanium, high density polyethylene, polyurethane, ultra high molecular weight polyethylene, flexible epoxy, polyvinylchloride and Kevlar®.

4) The lighting system of claim 1 wherein the light fixture fully encircles the hose discharge nozzle.

5) The lighting system of claim 1 wherein the light fixture is disposed on the hose discharge nozzle at a distance measuring in a range of 0 to 12 inches from the discharge port and wherein the two or more lights are disposed on the light fixture in a radius of a quarter of an inch to two inches from the surface of hose discharge nozzle.

6) The lighting system of claim 1 wherein the light fixture is a circuit board in wired and/or wireless communication with a regulated power source for powering the two or more lights.

7) The lighting system of claim 1 wherein the two or more lights are equidistantly spaced about the hose discharge nozzle.

8) The lighting system of claim 1 wherein the two or more lights are LED lights.

9) The lighting system of claim 1 wherein the two or more lights are fiber optic lights.

10) The lighting system of claim 1 wherein the two or more lights are halogen lights.

11) The lighting system of claim 1 wherein the two or more lights are incandescent lights.

12) The lighting system of claim 1, further comprising a protective lens affixed over the two or more lights.

13) The lighting system of claim 12 wherein the protective lens is produced from a material selected from a group consisting of polycarbonate, glass, and plastic.

14) The lighting system of claim 1 wherein the housing functions as a heat sink to dissipate heat generated by the two or more lights.

15) The lighting system of claim 14, further comprising a heat sink disposed between the light fixture and the housing.

16) The lighting system of claim 15 wherein the heat sink is a metal washer.

17) The lighting system of claim 1 wherein the pressurized medium is a fluid.

18) The lighting system of claim 1 wherein the pressurized medium comprises fluid and abrasive particulate matter.

19) The lighting system of claim 18 wherein the housing has a cambered profile such that no turbulent vortices form in a laminar airflow moving over the housing and hose discharge nozzle when the pressurized medium exits the discharge port.

20) The lighting system of claim 19 wherein the laminar airflow prevents abrasive particulate matter in the pressurized medium from impinging upon the two or more lights.

21) The lighting system of claim 1, further comprising a temperature sensor in communication with the light fixture, the temperature sensor automatically signaling the regulated power source to power off the two or more lights upon reaching a temperature in the range of 60 to 110 degrees Celsius.

22) The system of claim 21 wherein the temperature sensor automatically signals the regulated power source to power off the two or more lights upon reaching a temperature of 80 degrees Celsius.

23) An ergonomic actuation system for selectively discharging a pressurized medium from a discharge nozzle of a high pressure hose, the ergonomic actuation system comprising:
a) at least one switching element responsive to touch and disposed on the outer surface of the hose proximate to the discharge nozzle, wherein activation of the at least one switching element signals a discharge unit to discharge pressurized medium through the high pressure hose, the at least one switching element being substantially equally responsive at all points along its length,
i. wherein the at least one switching element adds no more than 1″ to the outer diameter of the high pressure hose, and
ii. wherein the at least one switching element is at least 1 foot in length and runs parallel to the high pressure hose; and
b) a communication means linking the at least one switching element to a control system of the discharge unit to communicate starting or stopping flow of the dispensed pressurized medium in response respectively to grasping or releasing the at least one switch.

24) The ergonomic actuation system of claim 23 wherein the communication means is an electrical wire.

25) The ergonomic actuation system of claim 23 wherein the communication means is a wireless transmitter.

26) The ergonomic actuation system of claim 23 wherein the at least one switching element is a pneumatic system comprising a fluid filled hose and a pressure switch disposed at the end of the hose for sensing a pressure differential in the fluid filled hose and communicating the pressure differential to the communication means.

27) The ergonomic actuation system of claim 26 wherein the fluid filled hose has an outer diameter measuring between 5 millimeters and 13 millimeters.

28) The ergonomic actuation system of claim 27 wherein the fluid filled hose has an outer diameter measuring 6 millimeters.

29) The ergonomic actuation system of claim 23, further comprising a control box disposed on the high pressure hose between the ergonomic actuation system and the control system, wherein the control box receives a signal from communication means, interprets the signal, and communicates with the control system through wired and/or wireless means to activate or deactivate flow of the pressurized medium.

30) The ergonomic actuation system of claim 29 wherein the signal is a change in voltage.

31) The ergonomic actuation system of claim 29 wherein the control box comprises a programmable logic controller for interpreting the signal.

32) The ergonomic actuation system of claim 29, further comprising a safety control mechanism disposed on the control box for enabling only intended activation of the at least one switching element.

33) The ergonomic actuation system of claim 23 wherein the at least one switching element is a mechanical actuator.

34) The ergonomic actuation system of claim 23 wherein the at least one switching element is an electrical capacitance switch.

35) The ergonomic actuation system of claim 23 wherein the at least one switching element is a hydraulic switch.
